(19) United States
(12) Patent Application Publication
(10) Pub. No.: US 2019/0226954 A1
(43) Pub. Date: Jul. 25, 2019

(54) MATERIAL TESTING MACHINE WITH UNEQUAL BIAXIAL STRETCH

(71) Applicant: Udayan Kanade, Pune (IN)

(72) Inventor: Udayan Kanade, Pune (IN)

(21) Appl. No.: 16/339,003

(22) PCT Filed: Oct. 3, 2017
(86) PCT No.: PCT/IB2017/056100

§ 371 Date: Apr. 3, 2019

(30) Foreign Application Priority Data
Oct. 3, 2016 (IN) 201621033687

(51) Int. Cl. G01N 3/08; G01N 3/04

(52) U.S. Cl. CPC G01N 3/08; G01N 3/04; G01N 2203/0676; G01N 2203/0017; G01N 2203/0282; G01N 2203/0254

(57) ABSTRACT

A machine that can stretch a material sample biaxially is disclosed. The material sample is gripped on four sides using two pairs of opposing gripping assemblies. Each gripping assembly comprises of multiple individual grippers which can slide towards or apart from each other. The two pairs of opposing gripping assemblies can be slid towards or away from each other, producing either equal or unequal stretches in the two directions. Each individual gripper slides in a direction perpendicular to the direction in which its respective gripping assembly can move as a unit. As the gripping assemblies are moved, the individual grippers are also moved in such a way as to maintain the rectangularity of a rectangular region of the specimen as much as possible.

This patent claims priority from provisional patent application 201621033687 titled “MATERIAL TESTING MACHINE WITH UNEQUAL BIAXIAL STRETCH” filed in Mumbai, India on 3 Oct. 2017.

### TECHNICAL FIELD

This patent relates to testing materials to find their mechanical properties. More specifically, the patent relates to preparation of a material sample, and construction and operation of a machine for testing that material sample.

### BACKGROUND ART

A well known method of testing materials to find mechanical properties is using a so-called “UTM” or universal testing machine. In this machine, a long specimen is held at its two ends using grippers, and these grippers are slowly pulled apart. The force experienced by the grippers for various elongations is measured, and mechanical properties are derived from these measurements.

Another lesser known method of testing materials is a biaxial testing machine, whereby a specimen is extended in a two-dimensional plane. There are biaxial testing machines which attempt to pull equally in all the in-plane directions, and others that pull in two distinct directions. Of the machines that pull in two distinct directions, there are machines that have single pairs of opposing grippers for each direction, or those that have multiple pairs of opposing grippers for each direction. One such system is presented in U.S. Pat. No. 6,487,902B1.

### DISCLOSURE OF INVENTION

### Disclosure

### SUMMARY

According to an embodiment of the present invention, a machine that can stretch a sample bi-axially is provided. The sample is gripped on four sides using two pairs of opposing gripping assemblies. Each gripping assembly comprises of multiple individual grippers which can slide towards or apart from each other. The specimen has a rectangular region, and protrusions which the grippers attach to. The two pairs of opposing gripping assemblies can be slid towards or away from each other, producing either equal or unequal stretches in the two directions. Each individual gripper slides in a direction perpendicular to the direction in which its respective gripping assembly can move as a unit. As the gripping assemblies are moved, the individual grippers are also moved in such a way as to maintain the rectangularity of the rectangular region of the specimen as much as possible.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 depicts a sample of the material to be tested, according to an embodiment.

FIG. 2 depicts a sample of the material to be tested, according to another embodiment.

FIG. 3 depicts a sample of the material to be tested, according to yet another embodiment.

FIG. 4 depicts an individual gripper with jaws, according to an embodiment.

FIG. 5 depicts an individual gripper, according to an embodiment.

FIG. 6 depicts an individual gripper having a member with a rectangular cross section, according to an embodiment.

FIG. 7 depicts an individual gripper having a member with an elliptical cross section, according to an embodiment.

FIG. 8 depicts an individual gripper having a member with a jelly bean shaped cross section, according to an embodiment.

FIG. 9 depicts a gripped sample, according to an embodiment.

FIG. 10 depicts a gripped sample, according to another embodiment.

FIG. 11 depicts a partial view of a material testing machine performing a test, according to an embodiment.

FIG. 12 depicts another partial view of a material testing machine performing a test, according to an embodiment.

FIG. 13 depicts yet another partial view of a material testing machine performing a test, according to an embodiment.

FIG. 14 depicts yet another partial view of a material testing machine performing a test, according to an embodiment.

FIG. 15 depicts an arrangement having a row of grippers with an equal distance mechanism, according to an embodiment.

FIG. 16 depicts a gripper unit according to an embodiment.

FIG. 17 depicts a gripper unit according to another embodiment.

FIG. 18 depicts a configuration with multiple gripper units on linear guide rails according to an embodiment.

FIG. 19 depicts a configuration with multiple gripper units on linear guide rails, according to another embodiment.

FIG. 20 depicts a configuration with multiple gripper units on linear guide rails, according to yet another embodiment.

FIG. 21 depicts an assembly comprising two rows of grippers aligned to the x-axis, according to an embodiment.

FIG. 22 depicts an assembly comprising four rows of gripper units, according to an embodiment.

FIG. 23 depicts an assembly comprising linear guide rails, according to an embodiment.

FIG. 24 depicts an assembly comprising linear guide rails, platform and screw, according to an embodiment.

### DETAILED DESCRIPTION

According to an embodiment of the present invention, a machine that can stretch a sample bi-axially is provided. The sample is gripped on four sides using two pairs of opposing gripping assemblies. Each gripping assembly comprises of multiple individual grippers which can slide towards or apart from each other. The specimen has a rectangular region, and protrusions which the grippers attach to. The two pairs of opposing gripping assemblies can be slid towards or away from each other, producing either equal or unequal stretches in the two directions. Each individual gripper slides in a direction perpendicular to the direction in which its respective gripping assembly can move as a unit. As the gripping assemblies are moved, the individual grippers are also moved in such a way as to maintain the rectangularity of the rectangular region of the specimen as much as possible.

Material Sample and its Preparation

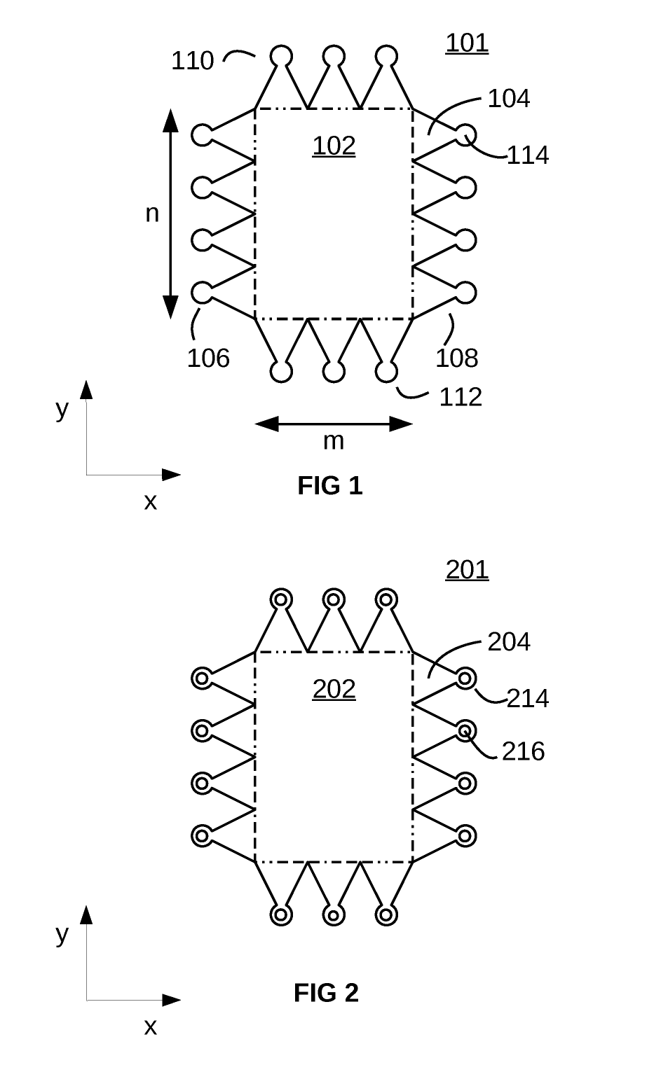

FIG. 1 depicts a sample 101 of the material to be tested, according to an embodiment. The material to be tested is provided as a sheet, in a shape that is schematically depicted in FIG. 1. The material to be tested may be a metal, concrete, an elastomer, a plastic, a rubber, a biological material, a woven material, a composite material or any other material whose mechanical characteristics are to be found.

The sample 101 has a rectangular region 102 to which protrusions 104 are attached. There are n protrusions on the sides 106, 108 extending in the y direction, and m protrusions on the sides 110, 112 extending in the x direction. In an embodiment, m and n may be the same number. In an embodiment, the rectangle 102 is a square. In various embodiments, either m, n or both may be 2, 3, 4 or 5.

The protrusions 104 may be of equal shape, or of one shape protruding out of the sides 106, 108 and another shape protruding out of sides 110, 112. and may be placed at equal distances on each side. The protrusions 104 may be touching each other, or the shapes may even merge into each other. The ends of the protrusions 104 may have tabs 114 such as enlarged discs (as shown in the drawing), or rectangles, etc., at the ends of the protrusions, for holding the protrusions.

The material sample 101 may be cut in the specified shape from a sheet using die cutting, laser or water jet cutting, wire cutting, CNC or EDM machining or any means of cutting and machining. Alternatively, the material sample may be cast, molded, extruded or additively manufactured directly in the specified shape, or by any other manufacturing method. The specified shape may be allowed to be in various thicknesses.

FIG. 2 depicts a sample 201 of the material to be tested, according to an embodiment. The sample 201 has a rectangular region 202 to which protrusions 204 are attached. The protrusions 204 may have tabs 214 such as enlarged discs, or rectangles, etc. at the end of the protrusions. In these tabs 214, holes 216 are provided, in which hooks or members will be placed for stretching. If the tabs 214 are absent, holes maybe provided in the protrusions 204 themselves.

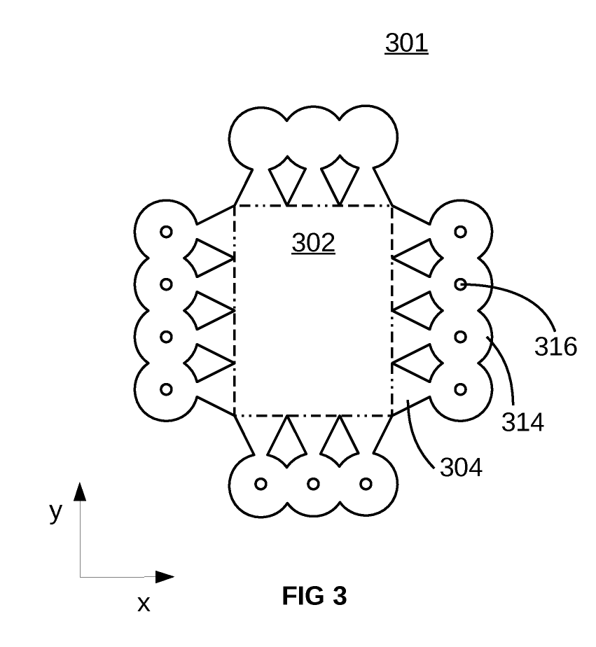

FIG. 3 depicts a sample 301 of the material to be tested, according to an embodiment. The sample 301 has a rectangular region 302 to which protrusions 304 are attached. The protrusions 304 have tabs 314 at the end that are fused together, forming continuous members along each side. The tabs 314 may have holes 316 provided in them, in which hooks or members will be placed for stretching.

Individual Grippers

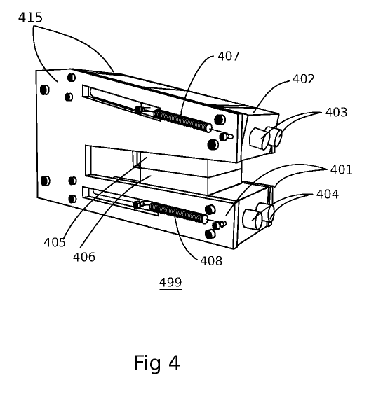

FIG. 4 depicts an individual gripper 499 with jaws, according to an embodiment. Gripper 499 has side plates 415 on which are mounted 802 on which are mounted guides 803 and 804 on which two jaws 805 and 806 slide back and forth. The guides 803 and 804 are not parallel to each other, and thus, the back and forth movement opens and closes the jaws. The jaws may be pulled towards closing by springs 407 and 408 anchored to the side plates by screws 801.

The jaws may be pulled back or pushed back to open for loading the sample, after which the sample protrusion is placed in the jaws. As the jaws close, the gripper 499 grips the sample. During operation of this invention, the gripper will pull the sample, causing the jaws to close even tighter. Many standard gripping mechanisms are also known in the art, and any gripping mechanism may be used with this invention.

FIG. 5 depicts an individual gripper 518, according to an embodiment. The gripper 518 has a member 520 on a platform 522. The member 520 hooks into a hole in the sample of the material to be tested. Optionally, the member 520 has threads 524 for screwing a cap so that the sample is not displaced during operation. The member 520 may have a circular cross section (as depicted), a rectangular cross section, an elliptical cross section or a jelly bean shaped cross section. If the member 520 has threads, the member 520 will have a circular cross section where the threads exist.

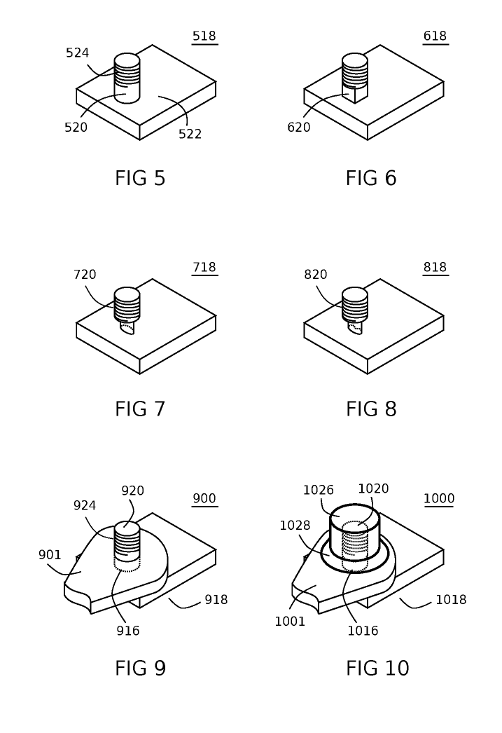

FIG. 6 depicts an individual gripper 618 having a member 620 with a rectangular cross section, according to an embodiment.

FIG. 7 depicts an individual gripper 718 having a member 720 with an elliptical cross section, according to an embodiment.

FIG. 8 depicts an individual gripper 818 having a member 820 with a jelly bean shaped cross section, according to an embodiment.

FIG. 9 depicts a gripped sample 900, according to an embodiment. A material sample 901 is placed such that the member 920 of the individual gripper 918 goes through the hole 916 in the material sample 901. Threads 924 on the member 920 may be used to screw a cap on top of the assembly so that the sample 901 is not displaced during operation.

FIG. 10 depicts a gripped sample 1000, according to an embodiment. A material sample 1001 is placed such that the member 1020 of the individual gripper 1018 goes through the hole 1016 in the material sample 1001. Threads on the member 1020 are used to screw a cap 1026 on top of the assembly so that the sample 1001 is not displaced during operation. The cap 1026 may have a flange 1028 for better gripping.

Material Testing Machine

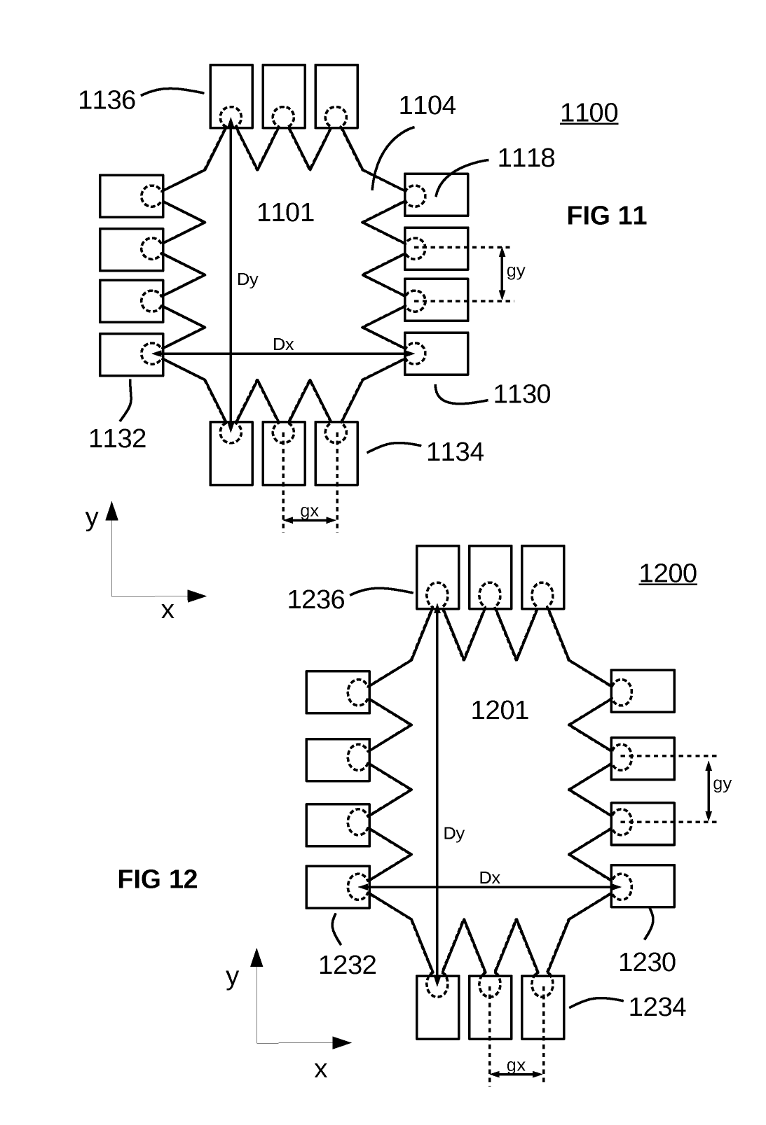

FIG. 11 depicts a partial view 1100 of a material testing machine performing a test, according to an embodiment. A material testing machine has grippers 1118 arranged in a rectangle, one for each protrusion 1104. The material sample protrusions 1104 are placed in the grippers 1118.

The material sample 1101 is loaded into the material testing machine by making each gripper 1118 grip the corresponding protrusion 1104 of the material sample 1101. Then, the grippers 1118 are moved to stretch the material sample 1101 mechanically in various ways.

The mechanical arrangement of the machine is such that once the material sample is loaded, the grippers 1118 can be moved by controlling four parameters. These parameters, depicted in FIG. 11 are as follows:

(a) The x-distance Dx between the two rows of grippers 1130, 1132 arranged along the y-axis.

(b) The y-distance Dy between the two rows of grippers 1134, 1136 arranged along the x-axis.

(c) The x-distance gx between any two adjacent grippers in the rows of grippers 1134, 1136 arranged along the x-axis.

(d) The y-distance gy between any two adjacent grippers in the rows of grippers 1130, 1132 arranged along the y-axis.

The movement of the grippers 1118 is constrained either mechanically or by a control system, or by a combination of both in such a way that the following constraints are always satisfied:

(a) The x-distance between any two adjacent grippers in the rows of grippers 1134, 1136 arranged along the x-axis will be exactly the same, and will be thus equal to gx.

(b) Similarly, the y-distance between any two adjacent grippers in the rows of grippers 1130, 1132 arranged along the y-axis will be exactly the same, and will be thus equal to gy.

(c) The y-coordinate of the centroid of each row of grippers 1130, 1132 arranged along the y-axis is at the center of the y-interval between the two rows of grippers arranged along the x-axis.

(d) Similarly, the x-coordinate of the centroid of each row of grippers 1134, 1136 arranged along the x-axis is at the center of the x-interval between the two rows of grippers arranged along the y-axis.

FIG. 12 depicts a partial view 1200 of a material testing machine performing a test, according to an embodiment. The distance Dy between the rows of grippers 1234, 1236 arranged along the x-axis has increased compared to the sample loading position, thus stretching the sample 1201 in the y direction. Simultaneously, the distance gy between adjacent grippers among the rows of grippers 1230, 1232 arranged along the y-axis has increased so that an even stretch is produced towards the middle of the sample 1201.

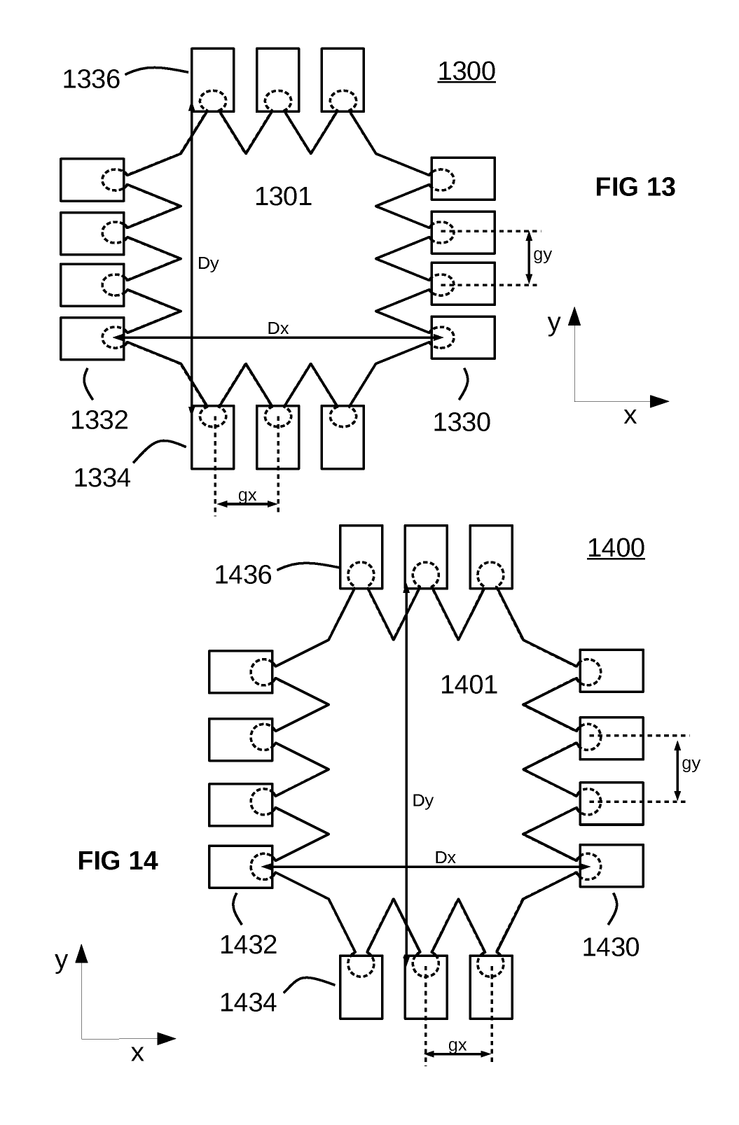

FIG. 13 depicts a partial view 1300 of a material testing machine performing a test, according to an embodiment. The distance Dx between the rows of grippers 1330, 1332 arranged along the y-axis has increased compared to the sample loading position, thus stretching the sample 1301 in the x direction. Simultaneously, the distance gx between adjacent grippers among the rows of grippers 1334, 1336 arranged along the x-axis has increased so that an even stretch is produced towards the middle of the sample 1301.

FIG. 14 depicts a partial view 1400 of a material testing machine performing a test, according to an embodiment. Both the distance Dy between the rows of grippers 1434, 1436 arranged along the x-axis and the distance Dx between the rows of grippers 1430, 1432 arranged along the y-axis has increased compared to the sample loading position, thus stretching the sample 1401 in both the x and y directions. The stretch produced in both the directions may be equal, or may be unequal. Simultaneously, the distance gy between adjacent grippers among the rows of grippers 1430, 1432 arranged along the y-axis, as well as the distance gx between adjacent grippers among the rows of grippers 1434, 1436 arranged along the x-axis has increased so that an even stretch is produced towards the middle of the sample 1401.

There are many ways in which gx and gy can be adjusted so as to produce an even stretch. Particular methods of doing this are given later in the patent.

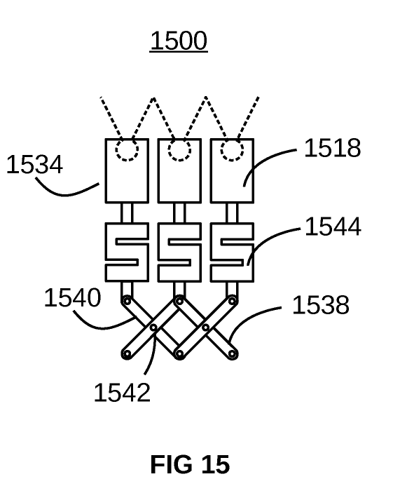

FIG. 15 depicts an arrangement 1500 having a row 1534 of grippers 1518 with an equal distance mechanism 1538, according to an embodiment. The equal distance mechanism 1538 is a series of rigid links 1540 connected by hinge or pivot joints 1542. The pivot joints 1542 may have bushings or bearings to reduce friction. Together, the equal distance mechanism 1538 forms a mechanism similar to a scissors mechanism or a pantograph, ensuring the x-distance between each line of hinge/pivot joints remains the same. This also ensures that the distance gx between the grippers 1518 remains the same, thus satisfying the constraint (a) mentioned above. Also depicted in FIG. 15 are load cells 1544 placed between the equal distance mechanism and the gripper. These load cells will measure the force experienced by each gripper while pulling the material sample.

The load cells 1544 measure force in tension. Alternatively, they may be able to measure force in both tension and compression. Further, the load cells may be able to measure force separately in multiple directions. E.g. the load cells may be able to resolve the force in the x and y directions, or even the x, the y and the z directions.

Similar arrangement exists for the other row of grippers arranged along the x-axis, or for the two rows of grippers arranged along the y-axis.

FIG. 16 depicts a gripper unit 1648 according to an embodiment. The gripper unit 1648 comprises a block 1654 with a load cell 1644 attached to it. Attached to the load cell 1644 is the gripper 1618, which may comprise platform 1622 and member 1620, or any means of gripping a sample of material. The load cell 1644 is connected electrically to load cell circuit board 1646 attached to block 1654. The load cell circuit board 1646 converts analog signal from load cell 1644 (usually in the form of voltage, current, resistance, capacitance or inductance) to digital data. This circuit is made using any of many well known techniques. For example, the load cell circuit board 1646 may have a power source (either battery, or a constant voltage or current source derived from another main power source), a single-stage or multi-stage amplifier and an analog to digital converter. The circuit board 1646 also has means of transmitting such digital data either on wires or wirelessly. Alternatively, the circuit board 1646 may only have amplifiers and signal conditioners, and pass analog signals ahead. Finally, the circuit board 1646 may not be present at all, and the unconditioned signal from the load cell 1644 may be passed to other parts of the machine. The block 1654 also has linear guide bearings 1652, which can slide on linear guide rails. The guide bearings 1652 may be of circulating ball type, or bushings, etc. The block 1654 may have one, two, three or more linear guide bearings.

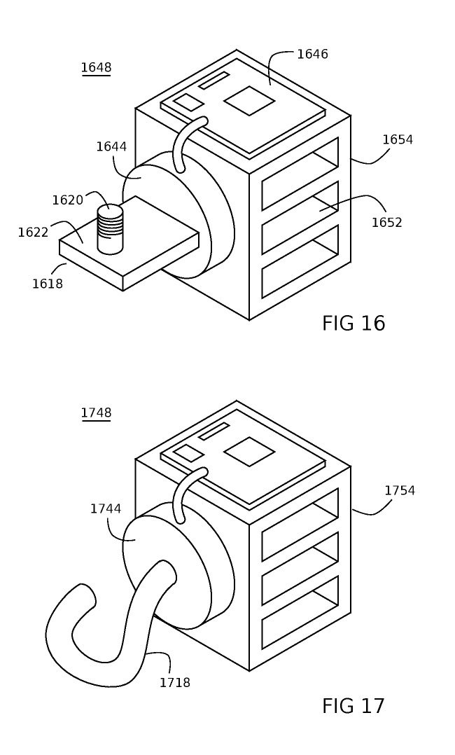

FIG. 17 depicts a gripper unit 1748 according to an embodiment. The gripper unit 1748 comprises a block 1754 with a load cell 1744 attached to it. Attached to the load cell 1744 is the gripper 1718, which in this case is a hook. The hook may be inserted into the holes in the protrusions in the sample of the material to be tested.

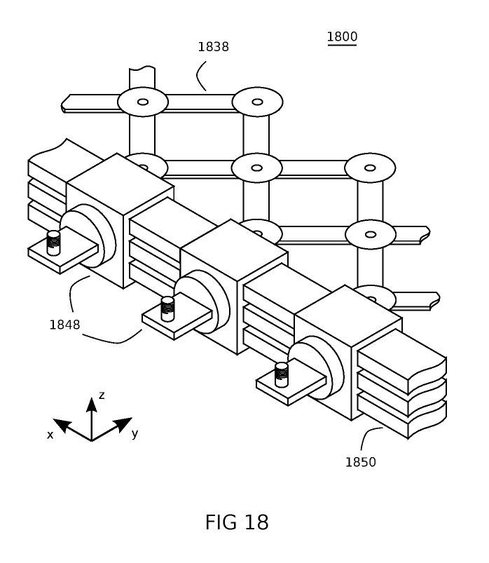

FIG. 18 depicts a configuration 1800 with multiple gripper units 1848 on linear guide rails 1850, according to an embodiment. There are one, two, three or more linear guide rails 1850. In an embodiment, the linear guide rails 1850 have rectangular cross section, with the longer side of the rectangle oriented in the y direction and the shorter side oriented in the z direction, for a configuration 1800 where the multiple gripper units 1848 are arranged along the x direction. In an embodiment, the linear guide rails 1850 are stacked in the z direction. Each gripper unit 1848 has linear guide bearings that slide on the linear guide rails 1850, as well as a load cell, optionally a load cell circuit board, and a gripper. The gripper units 1848 may be constrained together with an equal distance mechanism 1838, which may be a scissors mechanism as shown or any mechanism which will maintain equal distance between the gripper units 1848 mounted on the linear guide rails 1850.

In an embodiment, there are an odd number of gripper units 1848 mounted on the linear guide rails 1850, and the central among these gripper units is fixed immovably to the guide rails 1850, i.e. it does not slide along these rails. This will help ensure constraint (d) above.

Not all gripper units 1848 may be provided with a load cell. For those that are not, a geometrically equivalent block may be inserted for symmetry. If there is no load cell, there will be no load cell circuit board in that particular gripper unit.

Power and analog or digital signal connections need to be provided to each gripper unit, either for the gripper unit circuit boards, or for the load cells. In an embodiment, such power and signal conductors may be placed along the rigid links in the scissor mechanism of the equal distance mechanism 1838. The conductor transfers from the gripper unit 1848 to a link of the scissor mechanism, or from a link to another link using jump cables, or using rotary connectors (such as brush contacts).

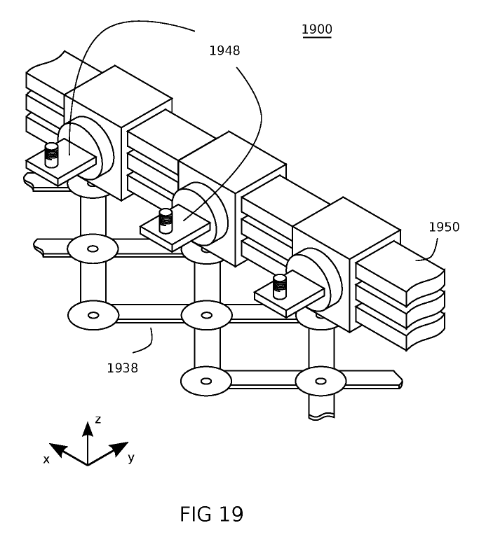

FIG. 19 depicts a configuration 1900 with multiple gripper units 1948 on linear guide rails 1950, according to an embodiment. An equal distance mechanism 1938 in the form of a scissors mechanism maintains equal distance between the gripper units. The equal distance mechanism may be attached on the same side of the gripper units 1948 as the load cells and grippers (as shown), or it may be attached on the opposite side of the grippers (as shown in FIG. 18). The equal distance mechanism may also be attached to the top or bottom sides (top and bottom faces being faces whose normal points in the positive or negative z direction) of the gripper units 1948.

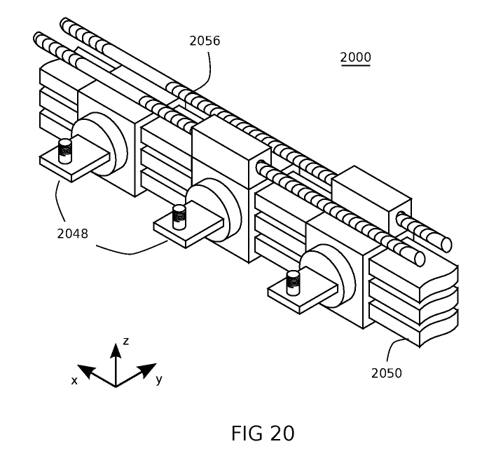

FIG. 20 depicts a configuration 2000 with multiple gripper units 2048 on linear guide rails 2050, according to an embodiment. Furthermore, there are multiple screws 2056 running parallel to the linear guide rails 2050. The central gripper unit is fixed to the linear guide rails 2050. Each pair of gripper units at equal distance from the central gripper unit are constrained to move when a particular screw of the multiple screws 2056 rotates. Each screw has threads of opposite sense in its two halves, and thus the two gripper units that are constrained to it will move in opposite directions. The multiple screws may be further constrained using gears or a control system to rotate in integer multiples of each other, thus constraining the various gripper units 2048 to have speeds in integer multiples of each other, thus ensuring that equal distance is maintained at all times.

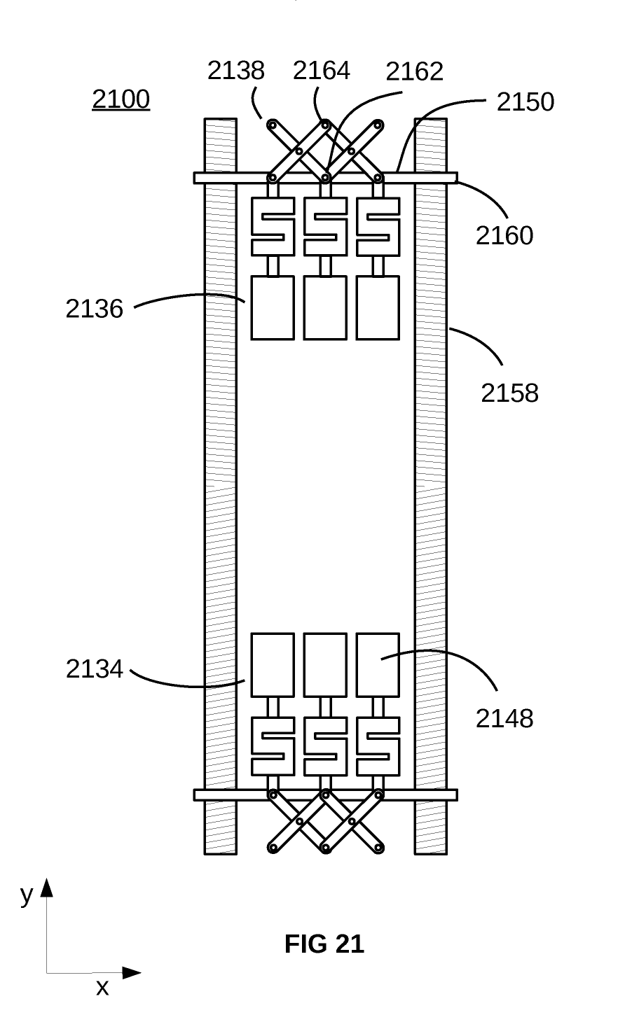

FIG. 21 depicts an assembly 2100 comprising two rows 2134, 2136 of grippers aligned to the x-axis, according to an embodiment. It depicts a mechanism to drive apart the two rows 2134, 2136 of grippers. A similar mechanism may be used to drive apart rows aligned to the y-axis. Two screws 2158 drive platforms 2160 on which are mounted the linear guide rails 2150 on which are constrained the pivots of the equal distance mechanisms 2138. The pivots of the equal distance mechanism 2138 may be constrained to the linear guide rails 2150 using the gripper units disclosed before. The gripper units (having grippers, optional load cells and constraints connecting to the equal distance mechanism) may slide on the linear guide rails 2150. The screws 2158 may be plain rotating screws or ball screws. The two screws 2158 are driven in tandem, possibly from a single motor using a coupling mechanism such as belt and pulley, or chain and sprocket, or a single shaft driving the two, or gears, or a combination of these mechanisms. Each of the screws 2158 has threads in one direction until half of the screw, and threads in the opposite direction for the remaining half. (A single shaft can be threaded in this way, or two oppositely threaded shafts may be coupled together to achieve this. If two opposite shafts are coupled together, a load cell may be inserted into this coupling to measure the compression force on the shaft of the ball-screw. This load cell may be the only load cell in the mechanism, and load cells in the gripper units may be avoided.) As the screws 2158 rotate, the platforms 2160 attached to them move closer together or apart from each other.

If the two screws 2158 are attached to the machine's fixed frame, the center of the y-interval between the two rows 2134, 2136 of grippers aligned to the x-axis is fixed at the center of FIG. 21. Now, if the mechanism of the rows of grippers (not shown) aligned to the y-axis is such that the y-coordinate of the centroid of each row is fixed, then constraint (c) disclosed above will be satisfied. Similarly, constraint (d) can be satisfied. One of the requirements of satisfying constraint (d) using the above technique is to ensure that the x-coordinate of the centroid of each row 2134, 2136 aligned to the x-axis is fixed. This is achieved by fixing the pivot of the center gripper unit, or the center gripper unit, on to the linear guide rails 2150, such that it cannot slide on the linear guide rails 2150.

The assembly 2100 actuates the distance Dy between the grippers. The equal distance mechanism 2138 is actuated separately to achieve the inter-gripper distance gx as required. The equal distance mechanism 2138 may be actuated by controlling the distance between the near pivot 2162 and far pivot 2164 corresponding to one of the gripper units (in an embodiment, the central gripper unit). The near pivot 2162 is controlled totally by the linear guide rails 2150, as it is fixed to the linear guide rails 2150. The position of the far pivot 2164 could be independently controlled by a different actuator, or a separate set of moving platforms and linear guides (in which case all the far pivots could be loaded onto them), or by adding an actuated link between the near pivot 2162 and far pivot 2164. This link may have an actuator motor with a brake. The motor makes the link tall or short as required, changing gx. The brake may be engaged at all times that the equal distance mechanism 2138 is not being actuated to change gx.

The gripper units 2148 may or may not be mechanically constrained to keep their orientation with respect to the x and y axes of the machine frame (i.e. to keep its loading axis parallel to either the x or the y axis). Various techniques may be used to mechanically constrain the orientation of the gripper units 2148, such as extending the link which connects the assembly to the near pivot all the way to the far pivot. The moving linear guides are constrained to maintain their orientation, so guides fixed to these moving plates may also be used.

Each gripper unit may have load cells. Only gripper units to one side 2134 may have load cells, or gripper units to both the sides 2134 and 2136 may have load cells. In any given side 2134 or 2136, all the gripper units may have load cells, or only the central gripper unit and gripper units to one of its sides may have load cells. Wherever load cells are not provided, equivalent geometric blocks may be inserted to maintain symmetry.

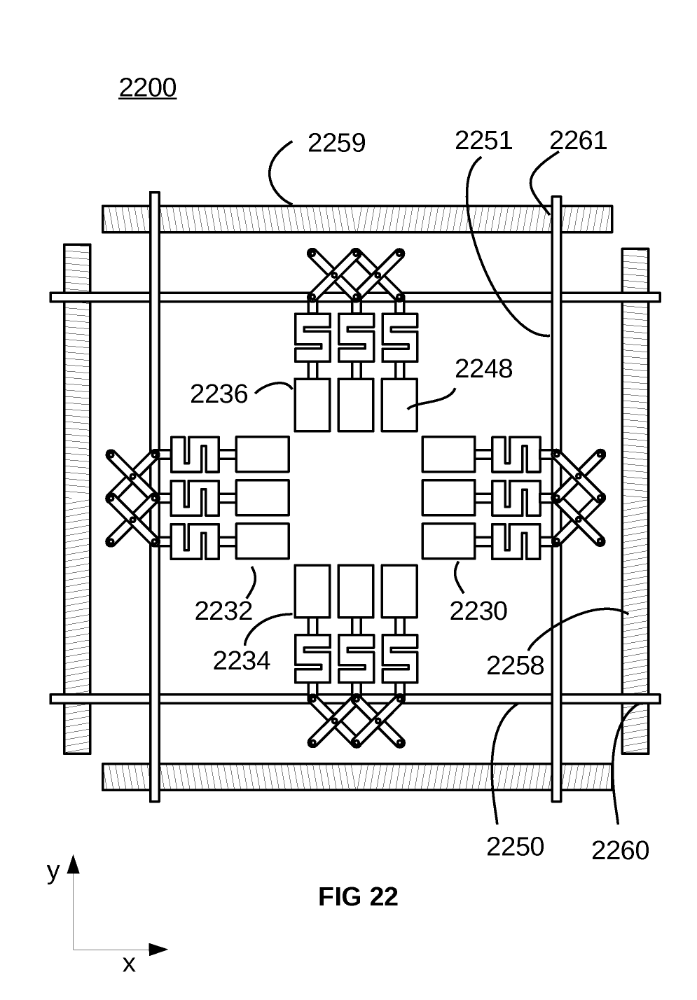

FIG. 22 depicts an assembly 2200 comprising four rows 2230, 2232, 2234, 2236 of gripper units 2248, according to an embodiment. Two rows 2230, 2232 of gripper units are arranged along the y-axis and other two rows 2234, 2236 are arranged along the x-axis. The rows 2234, 2236 of gripper units move on linear guide rails 2250 which are fixed to platforms 2260 which are attached to screws 2258. As the screws 2258 are rotated, the platforms 2260 move. Similarly, the rows 2230, 2232 of gripper units move on linear guide rails 2251 which are fixed to platforms 2261 which are attached to screws 2259. As the screws 2259 are rotated, the platforms 2261 move. The platforms 2260 can be moved towards or away from each other, and the platforms 2261 can be moved towards or away from each other, thus creating various states of strain.

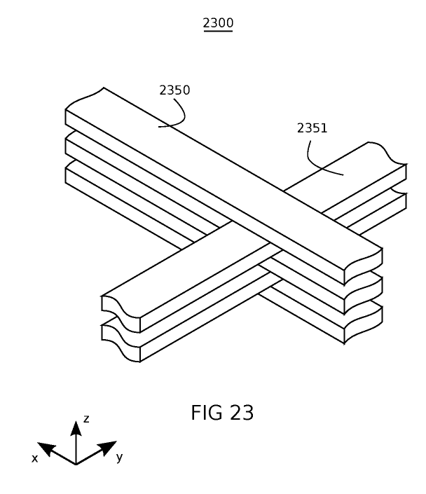

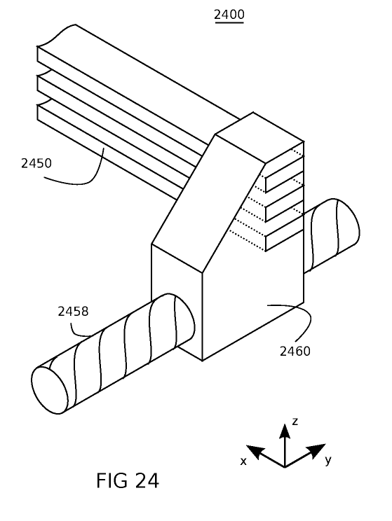

FIG. 23 depicts an assembly 2300 comprising linear guide rails 2350 and 2351, according to an embodiment. The linear guide rails 2350 are oriented along the x axis and the linear guide rails 2351 are oriented along the y axis. The linear guide rails 2350 move in the y direction and the linear guide rails 2351 move in the x direction. The linear guide rails 2350 are arranged alternately with the linear guide rails 2351. Gripper units are mounted on the linear guide rails (not shown).

FIG. 24 depicts an assembly 2400 comprising linear guide rails 2450, platform 2460 and screw 2458, according to an embodiment. The platform 2460 moves along the screw 2458 when the screw turns, because the platform 2460 is connected to the screw 2458 through a nut, i.e. something that has appropriate threads. Linear guide rails 2450 are fixed into the moving platform 2460. Linear guide rails have gripper units (not shown) sliding on them.

Procedure of Testing the Material

Various deformations of the material sample are created by the machine, and the force endured by each load cell is measured for each created deformation. In an embodiment, the machine has a camera which can take pictures of the stretched sample. The camera may be mounted with its optical axis perpendicular to the material sample sheet.

For uniaxial stretch, only one of Dx and Dy is changed from its initial value, and the other is kept a constant. In another kind of uniaxial test, the sample is loaded in only one of the opposing sets of grippers (say those along the x-axis) and the other grippers are kept away. The sample may have loading protrusions or holes on only two instead of all four sides in this case (or it may have protrusions or holes on all four sides, so that it can also be used for other tests).

For equi-biaxial stretch, both Dx and Dy are changed equally. For unequal biaxial stretch, Dx and Dy may be chosen to be any value. In a particular kind of test, a set of values of Dx and a set of values of Dy are requested, and for each requested value of Dx, every requested value of Dy is actuated. In other words, the cartesian product of the requested sets of Dx and Dy values are tested.

In an embodiment, the distances gx and gy are chosen to maintain the rectangularity of the original rectangular region as much as possible. (The rectangular region whose rectangularity is to be maintained may be the maximum possible rectangular region, as shown in FIG. 1, or it may be a smaller rectangle inside this rectangle.) This may be achieved in various ways: (the procedures below refer to choosing gx, but similar techniques shall be used for choosing gy as well)

(i) In an embodiment, one or more load cells in a gripper in a row aligned to the x-axis are able to measure forces not only in the axial direction, but in one or both perpendicular directions as well. gx is chosen to minimize such measured perpendicular force. Thus, a control system chooses gx to minimize such force, by searching various gx till one that minimizes the force is found. If more than one load cells in one or more rows aligned to the x-axis measure such perpendicular force, some combination (such as sum of squares of magnitude) of such perpendicular forces is minimized.

(ii) In an embodiment, gx is actuated to minimize the variation in forces on grippers in rows aligned to the x-axis. Variation may be calculated as sum of squares of errors from the mean force, or a similar measure of variation from the mean.

(iii) In an embodiment, a camera captures an image of the sample as the sample is deformed. The sample may have dotted or other patterns marked/printed/painted/drawn on it, from which an image processing algorithm can find out which original point of the sample has moved to which final location. Then rectangularity of the original rectangular region is measured using a camera and an image processing algorithm, and gx (as well as gy) is actuated gx to maximize this rectangularity.

(iv) In an embodiment, gx is actuated to minimize a combination of the rectangularity measures in (i), (ii) and (iii).

(v) In an embodiment, the equal distance mechanism is not actuated at all, but allowed to slide in an unhindered fashion. This will achieve a result similar to (i) above, since cross force will cause the mechanism to slide closer or apart till such cross force is minimized.

(vi) In an embodiment, the equal distance mechanism is not even included in the machine. Each gripper unit is allowed to slide unhindered on the linear guide rails.

(vii) In an embodiment, gx is always kept proportional to Dx. This may be done by appropriate control, or may be achieved by purely mechanical means (for example by including the linear guide rails arranged along the y-axis in the equal distance mechanism for the x-axis.). On the other hand, in most embodiments in this patent, gx is not kept proportional to Dx, in fact gx and Dx can be controlled independently. Similarly, gy and Dy can be controlled independently.

In an embodiment, various of the above techniques are used together. For example, while Dx/Dy/both are being actuated, gx/gy/both are changed using the rule (vii). This achieves an approximation to rectangularity which is better than not moving gx and gy at all. Once this is done, and Dx and Dy are fixed and not moving any more, one of the more accurate techniques such as (i), (ii), (iii) or (iv) is used to adjust gx/gy/both to more accurately achieve rectangularity.

Other Embodiments

The information created by this machine and this testing methodology can be fed to algorithms which fit various models of mechanical behavior to this data. Alternatively, the information created by this machine and this testing methodology can be used directly as the model of mechanical behavior.

The grippers may be created according to the patent application titled Multi-Axis Universal Material Testing System, having PCT publication number WO 2014/115130 A2 dated 31 Jul. 2014, which is incorporated herein by reference. The opening and closing of the grippers may be separately actuated, or may be achieved in the same way as described in the above mentioned PCT application (WO 2014/115130 A2 dated 31 Jul. 2014)—the grippers are pushed onto a plate which causes them to open for loading the sample.

In an embodiment, there is provision to subject the material sample to various atmospheric pressures. This may be achieved by subjecting the entire mechanism to the atmosphere of a different pressure, or by having seals between the grippers and the rest of the mechanism. The seals will move in two dimensions, requiring accordian-like separators between the pressurized and non-pressurized components. The pressure could be created using plain atmosphere, a different gas, or even a liquid such as water, oil, etc. It could also be feasible to create a system where the pressurizing fluid can be changed depending on the requirements of the test.

In an embodiment, a visual or touching or non-touch metrology (such as laser guaging) method is provided to measure the thickness of the material sample under various load conditions. Thickness may be measured at more than one points.

In an embodiment, only one of the pairs of rows of grippers is engaged, the other pair of rows of grippers is not engaged—they may be retracted back, or in a particular machine, they may even not be provided. This creates a better uniaxial test.

In an embodiment, at least one of Dx and Dy can be actuated to be lesser than the corresponding original dimension of the material sample.

In an embodiment a tri-axial material testing machine is provided. The three axes are mechanisms that pull in the x, y and z direction. Each axis mechanism may be a single gripper, or some axis mechanisms may be pairs of rows or pairs of matrices (two dimensional arrays) of grippers. In the case of matrices of grippers, they will have mechanical means to constrain them such that the distance between grippers adjacent in a particular direction will be the same. (There are two directions in which adjacent grippers may be found in a matrix). The sample is a rectangular parallelepiped, with protrusions on each face.

In an embodiment, only one pair of grippers is provided in one axis, or both the axes. In an embodiment, only one axis is present with one or multiple pairs of grippers. In these embodiments, the mechanism for providing a fluid with pressure is provided to subject the sample to various pressures.

In embodiments where the sample is subjected to various pressures, the sample may be subjected to both positive and negative pressures (relative to the atmosphere).

Environments for providing a particular chemical environment, or for setting various temperatures may also be provided.

Wherever “load cells” are mentioned in this disclosure, any known means of measuring force may be used. Wherever grippers are mentioned, any known gripping mechanisms may be used, in addition to the particular ones disclosed in this disclosure.

A machine that can stretch a material sample bi-axially is disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

1. A system having two pairs of rows of gripper units, each pair of rows arranged perpendicular to the other, each row within each pair of rows capable of moving towards or away from the other row within the same pair of rows, each row of gripper units capable of changing the distance between the gripper units in that row in such a way that the distance between any two adjacent gripper units is the same, a gripper unit consisting of a gripper and a load cell.

2. The apparatus of claim 1, wherein the distance between gripper units in a row is maintained equal using an equal distance mechanism, an equal distance mechanism being a mechanism comprising rigid links and pivot joints.

3. The apparatus of claim 1, wherein the distance between gripper units in a row is set using screws positioned parallel to the path of motion of the gripper units.

4. The apparatus of claim 1 further comprising a material sample gripped in all the grippers.

5. The apparatus of claim 4, wherein the distance between gripper units is maintained in such a way that a region of the material sample that is rectangular before being stretched becomes as rectangular as possible after the stretching.

6. The apparatus of claim 5, wherein the load cell in one or more gripper units is able to measure forces in the axial direction as well as one or more perpendicular directions, and the distance between the gripper units is maintained so as to minimize the measured perpendicular force or a combination of measured perpendicular forces.

7. The apparatus of claim 5, wherein the distance between gripper units is maintained so as to minimize the variation in forces measured by the load cells.

8. The apparatus of claim 5 further comprising a camera that measures rectangularity before and after the stretching.

9. The apparatus of claim 5, wherein the distance between gripper units is maintained so as to minimize a combination of measured perpendicular forces, measured variation in axial forces, and a measure of rectangularity measured by a camera.

10. The apparatus of claim 5, wherein the distance between gripper units in a row is maintained equal using an unactuated equal distance mechanism, an unactuated equal distance mechanism being a mechanism comprising rigid links and pivot joints that maintains equal distance between the grippers units while letting them slide freely on guide rails.

11. The apparatus of claim 5, wherein each gripper unit is allowed to slide freely on guide rails without explicit maintenance of equal distance between gripper units, the maintenance of equal distance as well as rectangularity being performed by the units sliding in response to perpendicular forces from the stretched sample.

12. The apparatus of claim 5, in which the distance between gripper units in a row of gripper units in a particular pair of rows of gripper units is maintained proportional to the distance between the other pair of rows of gripper units.
